(19) United States
(12) Patent Application Publication
(10) Pub. No.: US 2017/0048577 A1
(43) Pub. Date: Feb. 16, 2017

(54) REMOTE CONTROL METHOD RELATED TO HDMI-CEC SPECIFICATION AND SYSTEM THEREOF

(71) Applicant: JET OPTOELECTRONICS CO., LTD., Taipei City (TW)

(72) Inventors: JUH-FUH CHIOU, Taipei City (TW); MICHAEL TAI-HAO WEN, Taipei City (TW)

(21) Appl. No.: 14/952,855

(22) Filed: Nov. 25, 2015

(30) Foreign Application Priority Data
Aug. 14, 2015 (TW) 104126562

(51) Int. Cl. H04N 21/422; H04N 5/44

(52) U.S. Cl. CPC H04N 21/42225; H04N 5/4403; H04N 21/42221; H04N 2005/4426

(57) ABSTRACT

The disclosure is related to a remote control method related to an HDMI-CEC specification, and a system thereof. In the remote control method, a remote control program is initiated in a mobile device. The remote control program is activated to search for devices near the mobile device especially the devices that are supporting the specification of HDMI-CEC. The search result shows the options provided for user to select one device to be controlled. Under the HDMI-CEC-enabled system, one starting device and one or more peripheral devices are included in one scenario; and every device connected to a wireless signal transceiver being the controlled device is another scenario. The remote control program initiates a control interface corresponding to the selected device. Any control instruction generated is transmitted to the device to be controlled through the wireless signal transceiver.

### BACKGROUND

1. Technical Field

The present invention is related to a control method and system for controlling an electronic device; in particular to the remote control method for the device according to an HDMI-CEC specification, and the system using a computer.

2. Description of Related Art

HDMI (High Definition Multimedia Interface) is a proprietary audio and video interface for transferring uncompressed digital media. It is featured that HDMI uses one cable to carry both audio and video signals. HDMI is getting popular and becomes a standard for the home audio/video appliances. For example, the appliances adopting this high-definition media interface are such as a High-Definition Television (HDTV), a Set-Top Box (STB), a Blu-Ray Disc player, and a TV game console.

The association initiating the HDMI specification introduces an additional function, e.g. Consumer Electronics Control (CEC), to the HDMI standard.

The framework related to CEC specification utilizes a bidirectional signaling cable over a single-wire serial data bus to connect to a variety of CEC-enabled appliances. A remote control is also provided to control the CEC-enabled appliances over the standard CEC connections. FIG. 1 shows a schematic diagram of the CEC framework. A user manipulates the remote control 12. The remote control 12 generates control signals to a starting device, e.g. television 10. The signals are usually infrared signals. When the controlled devices, e.g. the peripheral devices 101, 102, and 103, are connected to the television 10, the CEC commands are transferred to the peripheral devices 101, 102, and 103 from the starting device over the CEC connection. It is noted that the peripheral devices 101, 102, and 103 are often the sources of audio and video. To control a peripheral device, a remote control pass through instruction is used to pass the control signals from the starting device to the peripheral device. The instructions allow the CEC control signals to operate the peripheral devices 101, 102, and 103 connected to the television 10 over HDMI cables. These peripheral devices (101, 102, and 103) are such as the set-top box, audio/video player, and game console.

The CEC framework allows one remote control to control the peripheral devices, which are connected to a primary CEC-enabled device, through the primary CEC-enabled device. The CEC specification effectively reduces number of the remote controls associated with the legacy audio/video appliances.

From this point on, every reference to HDMI-CEC means standard HDMI protocol with CEC enabled.

### SUMMARY

Provided in accordance with the present invention is a remote control method and a system related to the HDMI-CEC specification. The remote control method is applied to a computer which can be a mobile device. A remote control program such as an app is an application executed in the mobile device. The remote control program supports a variety of HDMI-CEC devices. The system renders a solution to substitute the legacy remote control, and also solves the problem that every appliance requires its dedicated remote control as well as the situation of losing the remote control.

First, a wireless signal transceiver is provided to be externally plugged to or built in every HDMI-CEC device that wants to be found wirelessly. The wireless signal transceiver has a wireless communication unit for receiving and sending wireless signals to the mobile device, a signal processing unit for processing the signals and creating the HDMI-CEC instructions, and a device connection unit for connecting with the electronic device.

In an embodiment, the remote control method allows a user to manipulate a computer such as a mobile device to run a remote control program. The remote control program starts to scan for the electronic devices around the mobile device with a wireless communication protocol such as Infrared, Bluetooth, Wi-Fi, Z-Wave, ZigBee, Wi-Fi Direct, or any other radio frequency wireless communication system. The mobile device therefore scans for the nearby devices per the wireless communication protocol used, and finds at least one starting device and one or more controlled devices. A display screen may be used to display the electronic devices according to a scan result.

In the beginning, the remote control program running on the mobile device displays a list of controlled devices. When a controlled device is selected, the remote control program renders a control interface. The control interface allows the user to generate a control instruction for the controlled device. The control instruction is converted to a wireless control signal. The wireless control signal is transmitted to the controlled device.

The instructions of remote control program are stored in a memory unit of the mobile device. The instructions executed by a processor in the mobile device include instruction for scanning for HDMI-CEC devices under a wireless communication protocol through each HDMI-CEC device's wireless signal transceiver; instruction for displaying the scan result; instruction for selecting one of the electronic devices; instruction for rendering the control interface; instruction for receiving user command through the control interface; instruction for converting the user command to a wireless control signal; and instruction for transmitting the wireless control signal to the electronic device's wireless signal transceiver.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram depicting a conventional HDMI-CEC system;

FIG. 2 shows a schematic diagram depicting a remote control system in one embodiment of the present invention;

FIG. 3 shows a schematic diagram depicting the circuit units constituting the remote control system according to one embodiment of the present invention;

FIG. 4 shows a diagram of function blocks of the remote control system in one embodiment of the present invention;

FIG. 5 shows a schematic diagram of the remote control system in one embodiment of the present invention;

FIG. 6 shows a schematic diagram of the remote control system in one embodiment of the present invention;

FIG. 7 shows a schematic diagram of the remote control system in one embodiment of the present invention;

FIG. 8A through FIG. 8D show the control interfaces for various controlled devices in a remote control software program executed in the mobile device of the present invention;

FIG. 9A through FIG. 9C show screenshots initiated by the software program executed in the mobile device in one embodiment of the present invention;

FIG. 10 shows a flow chart describing the remote control method according to one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

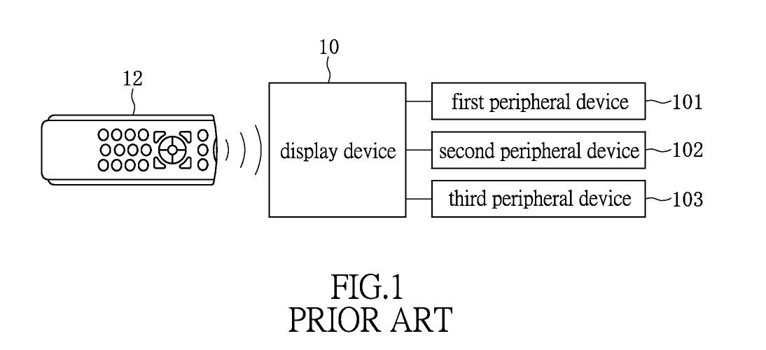

Our disclosure is different from the conventional HDMI-CEC technology described in FIG. 1. A new remote control method and system for controlling an electronic device is disclosed according to the invention. In the remote control method, a remote control program, e.g. app for portable device, is provided to conduct the remote control scheme. The device to be controlled may be an electronic device supporting the HDMI-CEC specification. The electronic devices are such as a television and other peripheral devices connected to the television via HDMI ports. The connection between the electronic devices is an HDMI-CEC connection. The peripheral device is such as a set-top box, an A/V player, or a game console.

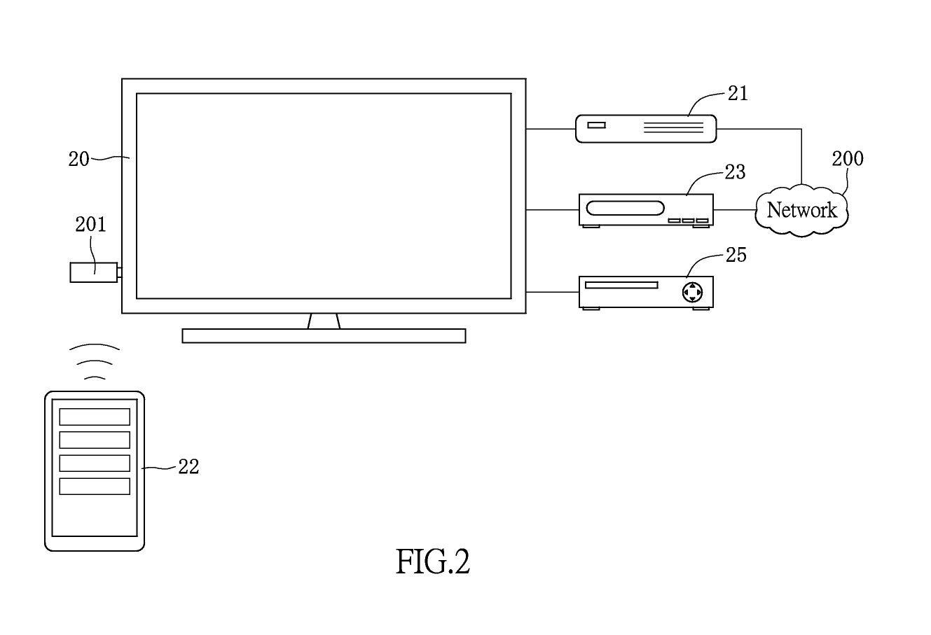

Reference is made to FIG. 2 showing a schematic diagram used to describe a remote control system supporting the HDMI-CEC specification.

In the system shown in the diagram, a display device 20 is such as a TV set used to display multimedia. In addition, the display device 20 can act as a starting device supporting the HDMI-CEC specification. The starting device is a device used to receive the signals transmitted from the mobile device 22. Further, there can be multiple starting devices in a system. The starting device communicates with other devices through HDMI-CEC. The starting device, e.g. the display device 20, is equipped with a wireless signal transceiver 201. The wireless signal transceiver 201 can be a hardware device externally connected to a starting device or a module built in the starting device. In the embodiment of the present invention, this display device 20 is able to communicate with the various peripheral devices over HDMI-CEC. The display device 20 allows the peripheral devices to display their content. The peripheral devices are such as game console 21, set-top box 23, and audio/video player 25. It is noted that the content of the game console 21 or set-top box 23 can be obtained over the network 200.

The user uses a mobile device 22 to install a remote control program to perform the remote control method. The remote control program can be a mobile application, i.e. app, installed in the mobile device 22. The remote control program is configured to establish connection with a wireless signal transceiver 201, which is plugged in or built in the display device 20, when the mobile device 22 runs the remote control program. A wireless communication protocol used is such as Bluetooth, Wi-Fi or Wi-Fi Direct, or any other radio frequency wireless specification.

In an exemplary embodiment, the wireless signal transceiver 201 can be an external hardware device. The wireless signal transceiver 201 is connected to the display device 20 via a physical interface such as USB and High Definition Multimedia Interface (HDMI) interface. The remote control program can issue commands to control the behavior of the display device 20. A HDMI-CEC (HDMI-Consumer Electronics Control) channel is established between the display device 20 and each of the peripheral devices 21, 23, and 25. These connections are in compliance with the HDMI-CEC specification. The peripheral device should be able to process the HDMI-CEC signals when it receives the signals based on the HDMI-CEC specification. It is also noted that these peripheral devices do not need to exist. If they do not exist, the mobile device 22 still will be able to control the display device 20.

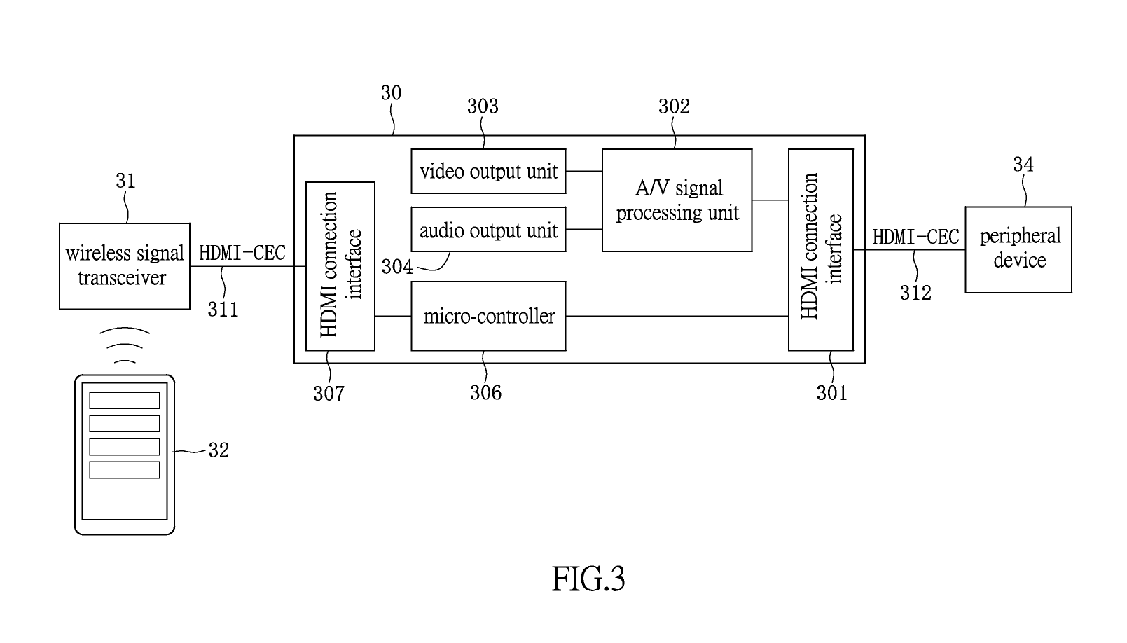

Next, reference is made to FIG. 3 showing the circuit units of the remote control system according to one embodiment of the present invention.

In the example, the display device 30 acts as an HDMI-CEC starting device. The display device 30 is connected to one or more peripheral devices (34) via the HDMI port that establishes the HDMI-CEC connection 312. The peripheral device 34 supports the HDMI-CEC specification and can process the related control signals.

A wireless signal transceiver 31 is externally connected to the display device 30 via the HDMI-CEC connection 311. The control signals are carried over the HDMI-CEC connection 311. In the remote control system, the remote control program executed in the mobile device 32 requires connecting or pairing with the wireless signal transceiver 31, which then transmits signals generated by the remote control program to the display device 30. The HDMI-CEC channel allows controlling a variety of peripheral devices over the HDMI connections.

The display device 30 is such as a TV set, or various peripheral devices 34 capable of displaying content. The display device 30 has an HDMI connection interface 301 used to transmit HDMI A/V signals and CEC commands with the peripheral device 34.

The wireless signal transceiver 31 is inserted into the HDMI connection interface 307, and they communicate via HDMI-CEC connection 311. The user manipulates the remote control program in the mobile device 32 to generate control instruction, convert the instruction into wireless control signals, and send them to the wireless signal transceiver 31. Then the wireless signal transceiver 31 generates the corresponding HDMI-CEC instructions and sends them to a micro-controller 306. Then the micro-controller 306 processes the instructions. If the instructions are for controlling the display device 30, the display device 30 will act accordingly. If the instructions are for controlling the peripheral device 34, the instructions will be sent to the peripheral device 34 from the HDMI connection interface 301 through HDMI-CEC 312. The control circuits, not shown in this diagram, of the peripheral device 34 perform the control instruction. For example, the control instruction could be to send A/V signals to the display device 30. In this case, the peripheral device 34 sends A/V signals to the HDMI connection interface 301 of the display device 30 via the HDMI-CEC connection 312. An A/V signal processing unit 302 of the display device 30 processes the audio/video signals and sends them respectively to a video output unit 303 and an audio output unit 304. In another example, the control instruction could be to lower the volume of the display device 30, in which case the micro-controller 306 will execute this command and lower the volume of the display device 30.

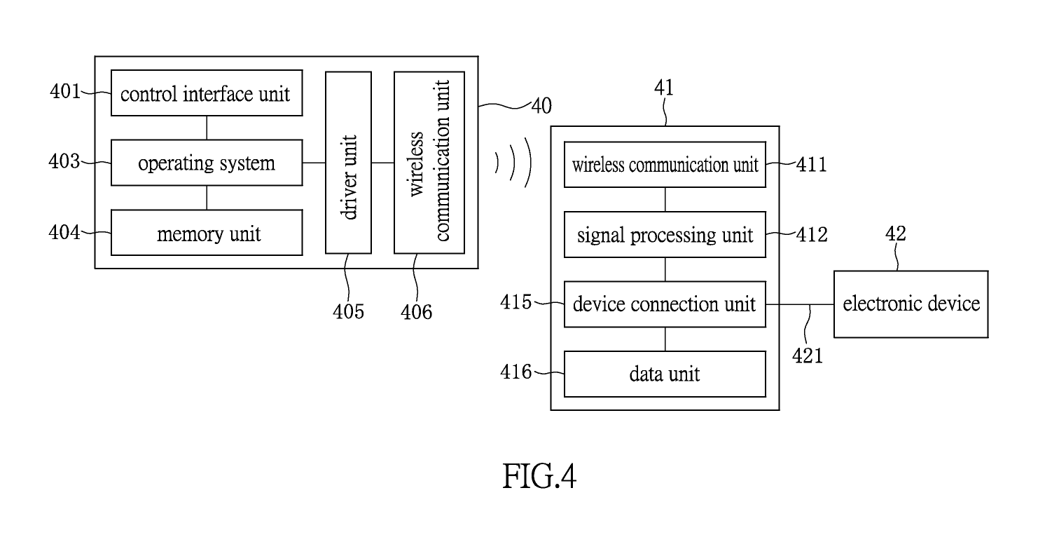

Reference is next made to FIG. 4 schematically showing the function blocks to describe the remote control system according to one embodiment of the present invention. A mobile device 40 includes a control interface unit 401, an operating system 403, a memory unit 404, a driver unit 405, and a wireless communication unit 406, which are the main circuit units used to send commands to the wireless signal transceiver 41. The wireless signal transceiver 41 includes a wireless communication unit 411, a signal processing unit 412, a device connection unit 415, and a data unit 416. The wireless signal transceiver 41 is connected to an electronic device 42 via a device connection 421. This device connection 421 is, but not limited to, such as an HDMI connection. It is noted that other types of connections are also applicable to the remote control system. Further, the wireless signal transceiver 41 can be an external device or a built-in module for the electronic device 42.

The mobile device 40 is such as an intelligent mobile phone, a tablet computer, or a legacy computer device that is used to conduct remote control functions. The mobile device 40 can have an operating system 403 installed in it that is used to run the remote control program, process the signals, and drive the circuit units. The remote control program controls the electronic devices. The remote control program is stored in the memory unit 404 of the mobile device 40.

The control interface unit 401 is an input device, for example a touch display. The operating system 403 runs the remote control program to render a user interface. Through the user interface, a search result, some options, and a control interface are displayed. When the control interface unit 401 receives a user input, the operating system 403 converts the user input into control instructions. The operating system 403 drives the wireless communication unit 406 through the firmware driver unit 405 to convert the control instructions into wireless signals which are transmitted out of the mobile device 40. After that, the wireless signal transceiver 41 receives the wireless control signals.

The wireless signal transceiver 41 includes a wireless communication unit 411 used to receive the signals from the mobile device 40, including the scan signals and wireless control signals made by the mobile device 40. The wireless communication unit 411 includes radio-frequency circuits in compliance with a specific wireless communication protocol.

The signal processing unit 412 converts the signals into the proper signal depending on the device connection 421. Suppose the device connection 421 is HDMI-CEC. Then the signal processing unit 412 converts the signals into HDMI-CEC instructions. The device connection unit 415 is a standard connection port, e.g. HDMI port, connected to the electronic device 42 or the like.

When the wireless signal transceiver 41 is plugged into the electronic device 42, the wireless signal transceiver 41 gets the identification data from the electronic device 42 through the device connection 421 and saves it in the data unit 416. If the electronic device 42 is connected to peripheral devices or if the wireless signal transceiver 41 is connected to more electronic devices, then the identification data of all those devices can also be retrieved by the wireless signal transceiver 41 and saved in the data unit 416. When the wireless signal transceiver 41 receives the scan signal from the mobile device 40, the wireless signal transceiver 41 sends the identification data to the mobile device 40.

When the scanning process initiated by the mobile device 40 is done, a scan result is created and can be stored in the memory unit 404. The memory unit 404 can also be the memory for the operating system 403, including the remote control program. In the scanning process, the remote control program gets the identification data from the wireless signal transceiver 41, which may save the data in the data unit 416. Next time when the mobile device 40 requests a scan, the wireless signal transceiver 41 may use the data saved in the data unit 416 if deemed reasonable. Further, for faster data retrieval, the identification data can be stored in the memory unit 404, and can be periodically synchronized with the data unit 416. It is noted that the identification data is such as a text ID associated with every controlled device, device model, control interface, and functionality.

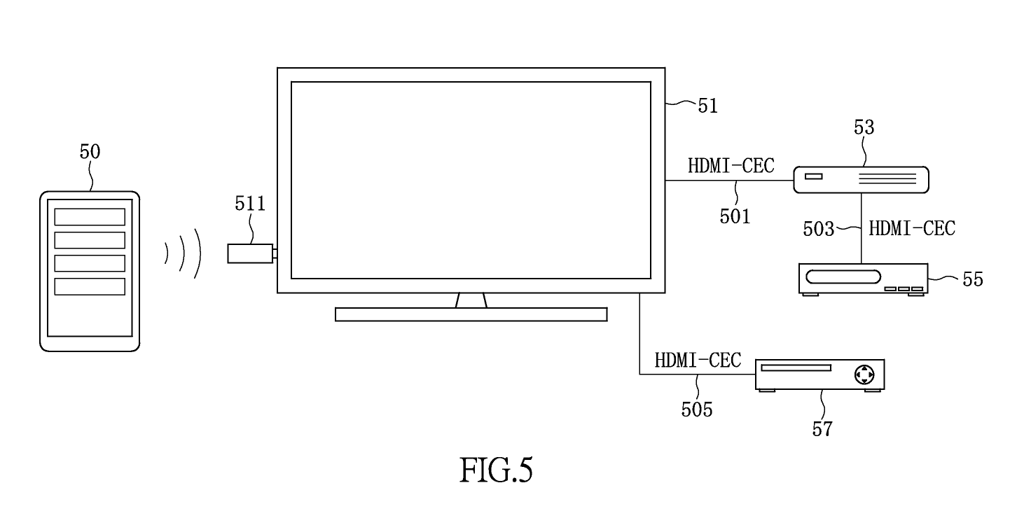

Reference is made to FIG. 5 schematically showing a framework of the remote control system according to one embodiment of the present invention. The framework shows a starting device and its connected devices.

A mobile device 50 acts as a remote control for the whole system. The starting device 51 has a wireless signal transceiver 511 which is in charge of communicating with the mobile device 50. The starting device 51 is connected to one or more peripheral devices over the HDMI-CEC connections. These peripheral devices become the controlled devices in the remote control system.

As the diagram shows, the starting device 51 acts as a main controlled device for the whole remote control system. The system allows the user using the mobile device 50 to control the starting device 51 directly through the wireless signal transceiver 511. Also, the remote control system allows the user to control the peripheral devices 53, 55, and 57 through this starting device 51. For example, the peripheral device 53, the peripheral device 57, and the starting device 51 can be connected via the HDMI-CEC connections 501 and 505. The mobile device 50 can acknowledge the existence of the peripheral devices 53 and 57 connected to the starting device 51 through the wireless signal transceiver 511 by the scanning process.

Also, the system supports the use case where a peripheral device is able to connect to other devices, for example the peripheral device 53 is connected to another device, e.g. a peripheral device 55, through the HDMI-CEC connection 503. Under this connectivity, the peripheral device 53 has at least two HDMI-CEC connection ports. Because the peripheral device 53 has two connection ports for respectively connecting with the starting device 51 and the other device, e.g. the shown peripheral device 55, the peripheral device 53 can be a bridge to link devices together. Therefore, the mobile device 50 can also acknowledge the existence of the peripheral devices 55 through the wireless signal transceiver 511 by the scanning process.

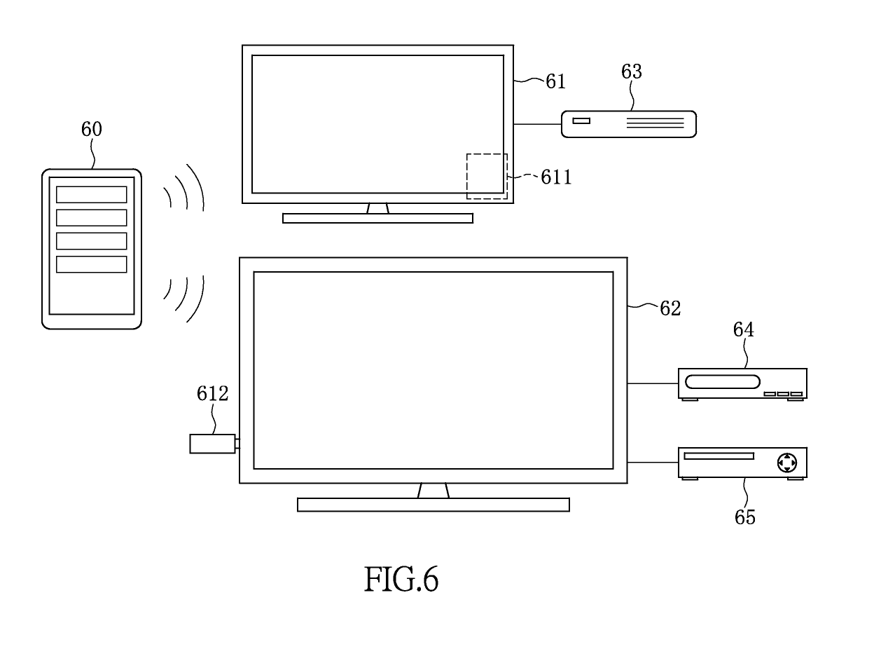

One further embodiment shown in FIG. 6 describes another framework of the remote control system of the present invention. The remote control system includes at least two starting devices and their connected peripheral devices.

In the current exemplary example, the system includes an HDMI-CEC starting device 61 and an HDMI-CEC starting device 62 that form two groups respectively connected to a peripheral device 63, a peripheral device 64, and a peripheral device 65. When the user manipulates the mobile device 60, he is required to select the HDMI-CEC starting device 61 or the HDMI-CEC starting device 62 to be controlled in first step. If he wants to control the selected starting device, then he is done selecting the controlled device. Otherwise, the user is required to select one controlled device among peripheral device 63, 64, and 65.

In one embodiment, all of the controlled devices can be displayed on the mobile device 60 in the beginning That means all the devices, e.g. the HDMI-CEC starting device 61, the HDMI-CEC starting device 62, the peripheral device 63, the peripheral device 64, and the peripheral device 65 are displayed for the user to select one controlled device.

For example, if the peripheral device 64 is the target device to be controlled, the user can use the mobile device 60 to generate a control instruction that instructs the HDMI-CEC starting device 62 to switch its source to the peripheral device 64. The mobile device 60 then generates further control instruction to the HDMI-CEC starting device 62, which forwards the instruction to the peripheral device 64. Another way to do the same thing is the mobile device 60 sends a control instruction to the wireless signal transceiver 612, and the wireless signal transceiver 612 automatically sends a list of instructions to the starting device 62 to achieve the goal of the control instruction. This means the wireless signal transceiver 612 has been programmed accordingly to do this.

When the remote control program is initiated in the mobile device 60, the program may use the saved configurations of the devices in the memory unit of the mobile device 60, or run a fresh scan to get the information related to the HDMI-CEC starting device 61, the HDMI-CEC starting device 62, and the peripheral devices 63, 64, and 65.

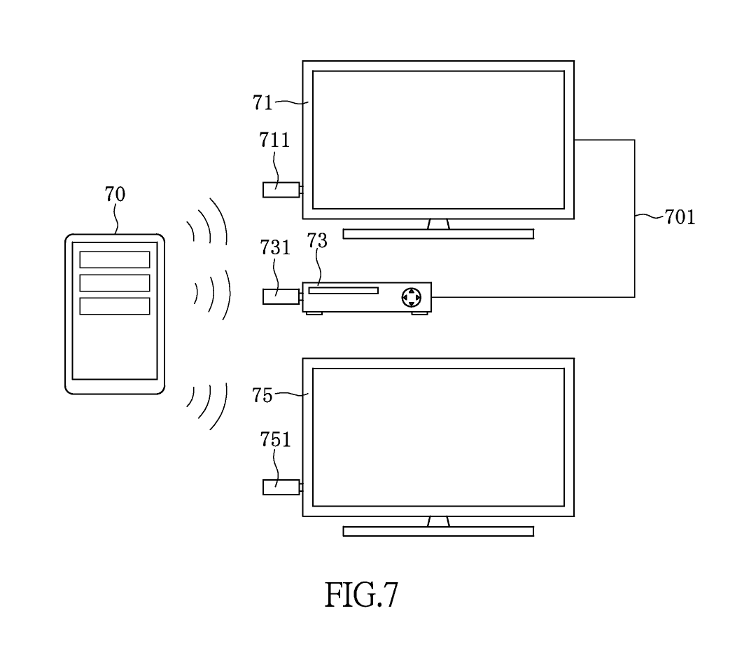

FIG. 7 shows one further framework of the system in one embodiment of the present invention. In this system, every electronic device can be controlled directly by the mobile device 70 because every device has its own wireless signal transceiver. The schematic diagram shows all the electronic device 71, 73, and 75 with wireless signal transceiver 711, 731, and 751. These wireless signal transceivers 711, 731, and 751 are under the control of the remote control program executed in the mobile device 70.

The electronic device 71, as shown in the diagram, can be a display device that has a wireless signal transceiver 711. One terminal of the electronic device 71 can connect to the electronic device 73 over an A/V connection 701. The electronic device 73 has a wireless signal transceiver 731 that is under the control of the mobile device 70. Under this framework, the electronic device 75 with the wireless signal transceiver 751 is also under the control of the mobile device 70.

In the operation of the system, the remote control program executed in the mobile device 70 scans for the nearby electronic devices (71, 73, and 75). Each of the wireless signal transceivers (711, 731, and 751) connected to the electronic devices (71, 73, and 75) responds to the scan signals broadcasted by the mobile device 70. The response signals may carry identification data of every wireless signal transceiver and the electronic device. Those data can be stored to the memory unit of the mobile device 70. The identification data allows the remote control program to recognize every controlled device and accordingly issue the control instruction.

When the remote control program is made to control an electronic device within this system, the remote control program is required to provide control interface associated with the electronic device being controlled. For example, according to the user's selection, the remote control program simulates a control interface corresponding to the electronic device 71, e.g. a TV set, provided for the user to operate. The electronic device 73 can be an A/V player, and the remote control program renders a control interface similar to the remote control of an A/V player. When the electronic device 71 is selected, the control interface initiated by the remote control program in the mobile device 70 becomes a TV remote control. When the electronic device 73 is selected as the controlled device, the control interface for the A/V player is generated. The electronic device 73 is directly controlled by the remote control program, and the electronic device 73 is behaving according to the control instruction. If the control instruction is for the electronic device 71 to play the electronic device 73's content, then the content is delivered to the electronic device 71 over the A/V connection 701.

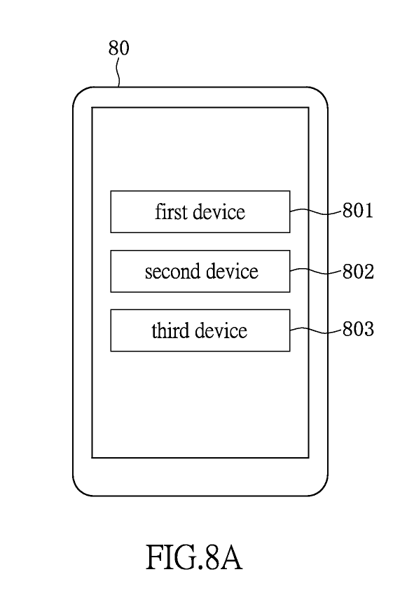

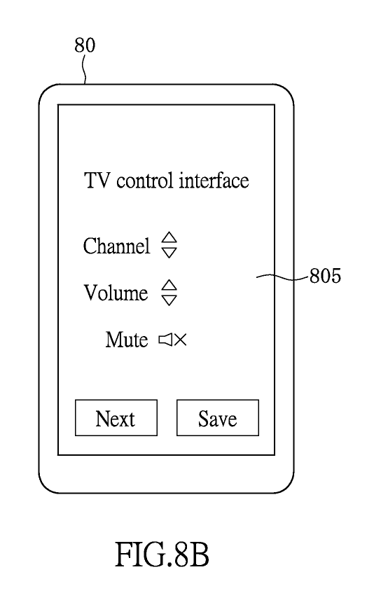

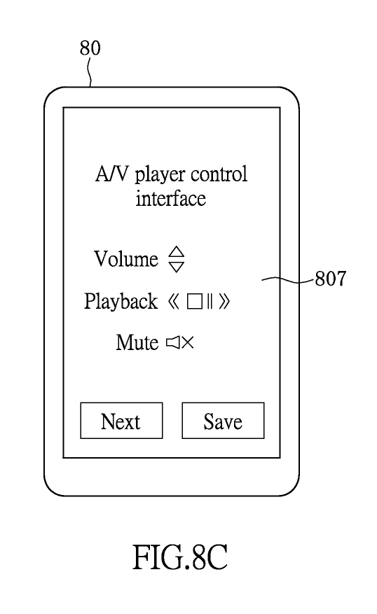

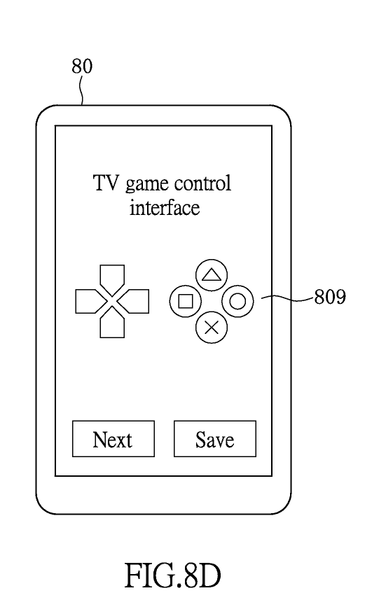

FIG. 8A through FIG. 8D show a series of screenshots schematically depicting the software-implemented control interfaces initiated in the mobile device.

When the mobile device completes scanning for nearby HDMI-CEC electronic devices, the result shows many kinds of recognizable electronic devices. The electronic device can be directly under the control of the mobile device; in addition, the electronic device can act as the starting device for the controlled peripheral device. The peripheral device is such as the A/V player, set-top box, and game console. The control interface corresponding to the selected controlled device and related settings is initiated in the mobile device. Every controlled device is adapted to one or a set of control interfaces.

In FIG. 8A, a setting interface is activated in the mobile device 80. The setting interface provides several setting options after completing scanning for the nearby electronic devices. One or more electronic devices can be listed on a display screen of the mobile device 80. The result exemplarily shows a first device 801, a second device 802, and a third device 803. A setting interface is then provided for configuring the control interface associated with every electronic device.

In FIG. 8B, a TV control interface 805 is shown. The remote control program executed in the mobile device 80 initiates the TV control interface 805 that displays options for TV control. The figure schematically shows the options including, but not limited to, TV channel, volume, and mute. A “next” button is shown below or on a specific location of the screen allowing the user to switch to next control interface. Another button “save” is used to save the current configuration as the control interface of the selected electronic device.

FIG. 8C shows a schematic diagram of an A/V player control interface 807. The interface 807 includes several control options including, but not limited to, volume, playback and mute for the A/V player. The button “next” is clicked when the current A/V player control interface 807 is not for the selected electronic device. Otherwise, the current setting can be saved when the control interface is correctly corresponding to the selected electronic device.

FIG. 8D shows a schematic diagram depicting a TV game control interface 809. The control interface shows the control buttons for the TV game. The setting is saved when the control interface is corresponding to the selected electronic device; or the next control interface may be suitable for the selected device.

Once a particular control interface has been associated with a particular device, the remote control program remembers this decision and next time will present the user with the correct control interface once a controlled device is selected. The remote control program allows the user to change the association if he so desires.

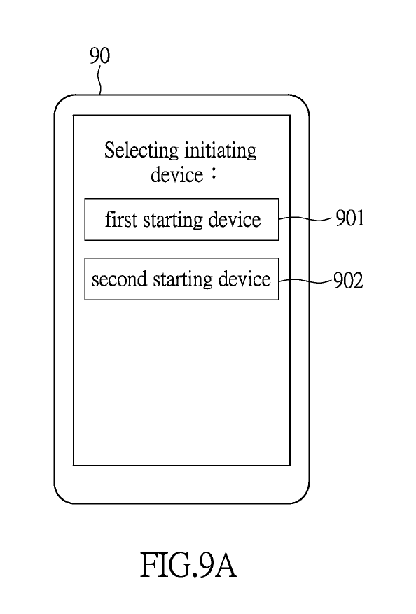

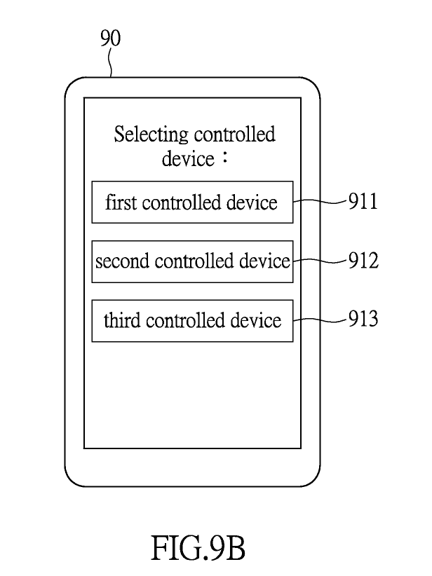

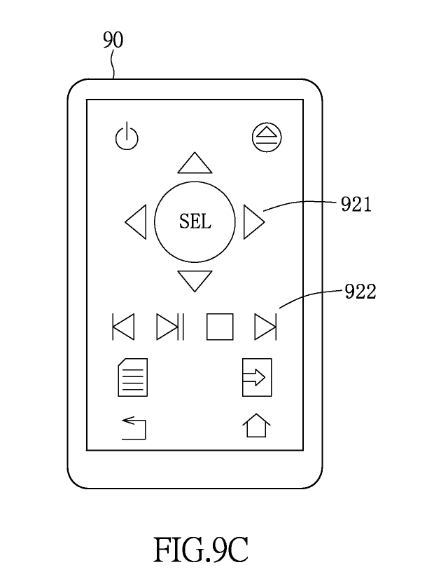

In another embodiment, the remote control program can provide friendly graphical user interface as described in FIG. 9A through FIG. 9C.

In FIG. 9A, a remote control program is executed in a mobile device 90, and uses a wireless communication protocol to scan for the nearby HDMI-CEC-enabled devices. A controlled device can be a starting device or a peripheral device. As shown in the diagram, a first starting device 901 and a second starting device 902 shown on the mobile device 90 are the options asking the user to make a selection.

Once the user selects a starting device, the control interface can ask him whether the selected starting device is the one he wants to control. If so, then the user is done selecting the controlled device. Otherwise, the user is taken to FIG. 9B which exemplarily lists all the peripheral devices of the selected starting device. He then selects a peripheral device to control. Then, in one embodiment, FIGS. 8B-8D proceed to allow the user to associate a particular control interface with the selected controlled device. In another embodiment, FIG. 9C depicts a “universal” remote control, which includes all function keys so that the user will be able to execute the desired function regardless of the type of the controlled device. The control interface includes several control items such as an orientation control function 921, a playing control function 922, and buttons associated with various functions. The schematic diagram does not limit the scope of the present invention.

When the scanning process is done, a scan result is displayed on a display screen of the mobile device 90. The scan result can be stored in a memory unit 404 as shown in FIG. 4. The memory unit 404 may store at least one scan result retrieved by the remote control program. If there is data in the memory unit, the remote control program may display the saved scan result without doing a fresh scan unless the user requests a fresh scan. If there is no data in the memory unit, the remote control program will need to do a fresh scan.

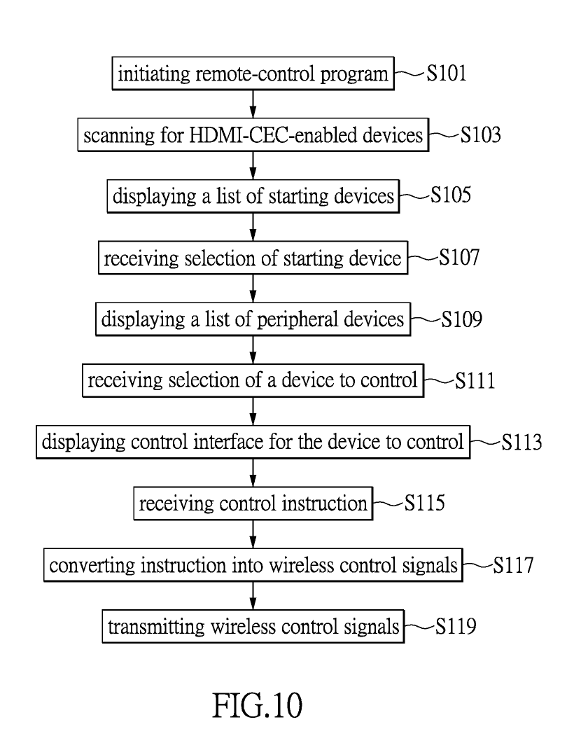

Reference further is made to FIG. 10 showing a flow chart describing the remote control method according to one embodiment of the present invention.

In the beginning of the process, such as in step S101, the remote control program in the mobile device is initiated. In step S103, the remote control program scans for the HDMI-CEC-enabled devices, and acquires information related to them. The wireless communication protocol operated among the devices can be Bluetooth, Wi-Fi, or Wi-Fi Direct, or any other radio frequency wireless specification.

Next, in step S105, according to the instant scan result or the data in the memory unit, one or more starting devices can be displayed on the mobile device. In step S107, if the user selects one starting device to be the controlled device, then we go straight to step S113. Otherwise, we go to step S109, where the peripheral devices of the selected starting device are listed. In one further embodiment, the options including all the controlled devices described in the steps S105, S107 and S109 can be displayed on one single screen. Further, for easier identification, the starting device or the controlled device can be labeled with numbers or names.

Next, in step S111, the user selects one electronic device to control. The remote control program then acknowledges the selection of one controlled device, and initiates a control interface associated with the selected controlled device, as shown in step S113.

It is noted that the control interface specified for the controlled device can be referred to by the schematic diagrams shown in FIG. 8B through FIG. 8D and FIG. 9C. The goal is to associate a suitable control interface with the controlled device. In an example, the remote control program shows a set of pre-loaded control interfaces for the user to select one. In an exemplary example, when a new peripheral device is added to the system, the mobile device is required to download the control interface corresponding to the new peripheral device. In another aspect of the invention, the control interface can be instantly downloaded over network when the peripheral device is selected to be the controlled device.

After showing the control interface, the remote control program receives a control instruction made by the user through the control interface, as shown in step S115. In step S117, the remote control program converts the control instruction into wireless control signals that comply with a specific wireless communication protocol. The wireless control signals are delivered to the wireless signal transceiver of the starting device, as shown in step S119. When the remote control program issues the control instruction, the instruction may be passed through from one device to another. Finally, the control instruction can reach the selected controlled device for the device to execute. In the remote control system according to the disclosure, a remote control program installed in a mobile device is a primary element of the system; and a built-in or external wireless signal transceiver prepared for the starting device is also one of the major components. In scenarios where the current HDMI-CEC standard does not support, the elements in these scenarios may need to be customized. To sum up the above embodiments, the instructions generated by the remote control program reflect the functionalities of the remote control program. The instructions include instruction for scanning for HDMI-CEC-enabled electronic devices around the mobile device under a wireless communication protocol; instruction for displaying the scanned electronic devices around the mobile device; instruction for selecting one of the electronic devices; instruction for displaying a control interface associated with the selected electronic device; instruction for receiving a control instruction generated through the control interface; instruction for converting the control instruction to a wireless control signal; and instruction for transmitting the wireless control signal to the electronic device.

In summary, a part of the remote control method and system in the disclosure is compliant with the HDMI-CEC specification. The remote control program in the mobile device acts as a remote control which substitutes for the conventional remote control. The remote control program renders options for selecting a controlled device and the control interface. The wireless signal transceiver is able to convert the control instruction into the instructions under the HDMI-CEC specification. The invention provides a convenient way to implement remote control for the HDMI-CEC-enabled devices, and also solves the problem of inconvenience of having too many remote controls in a novel way.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A remote control method, comprising:
using a computer to display a list of at least one electronic device supporting HDMI-CEC specification by scanning for one or more electronic devices around the computer under a wireless communication protocol; wherein the electronic device has an external or a built-in wireless signal transceiver, and the wireless signal transceiver includes a wireless communication unit used to receive wireless control signals issued by the computer and a signal processing unit used to process the signals;
the computer receiving a selection of one electronic device;
the computer initiating a connection with the selected electronic device;
the computer running a remote control program which displays a control interface showing a plurality of control buttons for controlling the selected electronic device;
the remote control program receiving a control instruction generated through the control interface by a user;
converting the control instruction to a wireless control signal;
transmitting the wireless control signal to the electronic device, wherein the signal processing unit of the wireless signal transceiver converts the wireless control signal into an HDMI-CEC instruction that the electronic device supports; and
the electronic device performing an action according to the HDMI-CEC instruction.

2. (canceled)

3. The method of claim 1, wherein one of the electronic devices is a starting device which is connected to one or more peripheral devices over HDMI-CEC, and the user can instruct the starting device to switch its content source to one of the peripheral devices.

4. The method of claim 1, wherein the wireless signal transceiver provides information in response to scanning for one or more electronic devices; the scan result is displayed on the display screen of the computer.

5. The method of claim 1, wherein a process to display the control interface associated with the selected electronic device comprises:
showing a list of available control interfaces;
receiving the selection of a control interface; and
associating the selected control interface with the selected electronic device;

6. The method of claim 4, wherein the scan result contains identification data of the found electronic devices and the scan result may be recorded in a memory unit of the computer.

7. The method of claim 1, wherein the wireless communication protocol is Infrared, Bluetooth, Wi-Fi, Z-Wave, ZigBee, or Wi-Fi Direct which scans for the HDMI-CEC-enabled devices and acquires their information.

8. A remote control system, comprising:
a wireless signal transceiver external to or built in an electronic device comprising:
a wireless communication unit used to receive signals including wireless control signals transmitted by a computer;
a signal processing unit used to process the signals made by the computer, so as to convert the wireless control signals into instructions supporting HDMI-CEC specification; and
a device connection unit used to connect to the electronic device;
a computer, and instructions executed by the computer comprising:
instruction for scanning for a plurality of electronic devices supporting the HDMI-CEC specification through their wireless signal transceivers around the computer under a wireless communication protocol;
instruction for displaying the found electronic devices around the computer;
instruction for selecting one of the electronic devices;
instruction for connecting to the selected electronic device;
a remote control program executed by the computer, wherein the remote control program is saved in the computer, and instructions executed by the remote control program comprising:
instruction for displaying a control interface showing a plurality of control buttons for controlling the selected electronic device;
instruction for receiving a control instruction generated through the control interface by a user;
instruction for converting the control instruction to a wireless control signal;
instruction for transmitting the wireless control signal to the wireless signal transceiver.

9. The system of claim 8, wherein the remote control program is an application program installed in the computer; the computer is initiated to scan for one or more electronic devices supporting HDMI-CEC specification around the computer under the wireless communication protocol; and wherein the device connection unit connects the wireless signal transceiver and the electronic device over HDMI-CEC.

10. The system of claim 8, wherein the computer includes a memory unit used to save the identification data of the found electronic devices.

11. The system of claim 9, wherein the information in response to scanning for one or more HDMI-CEC-enabled electronic devices around the computer is obtained from the wireless signal transceiver.

12. The system of claim 11, wherein one of the electronic devices is a starting device.

13. The system of claim 12, wherein the starting device is directly connected to one or more peripheral devices over HDMI-CEC, and the user can instruct the starting device to switch its content source to one of the peripheral devices.

14. The system of claim 13, wherein the peripheral device includes a port to connect to the starting device, and another port to connect to another peripheral device over HDMI-CEC.

15. A remote control system, comprising:
an electronic device;
a wireless signal transceiver, built into or plugged into the electronic device, including a wireless communication unit used to receive wireless control signals over a wireless connection, and a signal processing unit used to process the wireless control signals, and to convert the wireless control signals into HDMI-CEC commands for the electronic device to execute;
a computer for scanning for a plurality of electronic devices, displaying the found electronic devices, allowing the selection of one electronic device to control, and connecting to the selected electronic device;
a memory storing a remote control program, wherein the remote control program is executed by the computer for displaying a user interface showing a plurality of control buttons for controlling the electronic device, generating a control instruction via a user, converting the control instruction into the wireless control signal, and transmitting the wireless control signal to the wireless signal transceiver.

16. The system of claim 15, wherein the electronic device is HDMI-CEC-enabled, and the wireless signal transceiver communicates with the electronic device over HDMI-CEC, and the wireless signal transceiver converts the wireless control signal into an HDMI-CEC command and sends the HDMI-CEC command to the electronic device for the electronic device to execute.

17. The system of claim 16, wherein the remote control program is an application program installed in the computer.

18. The system of claim 16, wherein one of the electronic devices is a starting device.

19. The system of claim 18, wherein the starting device is directly connected to one or more peripheral devices over HDMI-CEC, and the user can instruct the starting device to switch its content source to one of the peripheral devices.
